(19) United States
(12) Patent Application Publication
(10) Pub. No.: US 2015/0027997 A1
(43) Pub. Date: Jan. 29, 2015

(54) WELDING TORCH, WELDING APPARATUS AND METHOD OF WELDING USING HOLLOW ELECTRODE AND FILLER MATERIAL

(71) Applicants: Ernst Miklos, Kirchheim (DE); Faith Savgu, Munich (DE)

(72) Inventors: Ernst Miklos, Kirchheim (DE); Faith Savgu, Munich (DE)

(21) Appl. No.: 14/333,900

(22) Filed: Jul. 17, 2014

(30) Foreign Application Priority Data
Jul. 26, 2013 (EP) 13003746.8

(51) Int. Cl. B23K 9/133; B23K 9/167; B23K 9/08; B23K 10/02

(52) U.S. Cl. CPC B23K 9/133; B23K 10/02; B23K 9/167; B23K 9/08
USPC 219/75; 219/137.31; 219/123; 219/121.5; 219/137 R; 219/121.46

(57) ABSTRACT

A welding torch having guidance means designed to advance a wire-like welding filler material mechanically along an axis at least in a section of the welding torch, a process gas nozzle that coaxially surrounds at least the guidance means, and a welding current connector that is connected in electrically conductive manner to an element of the welding torch that is configured to conduct electrical current. A hollow electrode is provided that surrounds the axis coaxially and as the element configured for conducting current is connected in electrically conductive manner to the welding current connector, wherein the guidance means are designed to advance the wire-like welding filler material in potential free manner. The welding torch may be used as part of a welding apparatus for a variety of welding methods.

### CROSS REFERENCE TO RELATED APPLICATIONS

The present application claims priority from European Patent Application EP 13003746.8 filed Jul. 26, 2013.

### BACKGROUND OF THE INVENTION

The invention relates to a welding torch with guide means for potential-free guidance of a wire-like filler material, a welding apparatus that comprises such a torch, a corresponding welding method, and the corresponding use of a process gas.

A person skilled in the art will be familiar with several different welding methods from the prior art, each of which is particularly suitable for certain welding tasks. An overview of such methods is provided in publications such as: Dilthey, U.: Schweiβtechnische Fertigungsverfahren 1: Schweiβ- und Schneidtechologien, [Welding methods for manufacturing 1: Welding and cutting technologies]. 3^{rd} edition, Heidelberg: Springer, 2006, or Davies, A. C.: The Science and Practice of Welding, 10^{th} edition, Cambridge: Cambridge University Press, 1993.

In Tungsten Inert Gas (TIG) welding, a welding arc burns between a non-melting tungsten electrode and the workpiece that is being processed. This causes the workpiece to melt. In order to protect the tungsten electrode and the weld pool created thereby from oxidation, at least one suitable process gas is used to cover that tungsten electrode and the weld pool. The tungsten electrodes used in TIG welding methods have different diameters depending on the current load, and are typically tapered to a point like a pencil. They usually contain additives of rare earth oxides to lower the electron work function, which makes the arc easier to ignite and increases the stability thereof. In TIG welding, work is typically carried out in an inert, material-dependent, but occasionally also in a reducing atmosphere.

With TIC welding methods, it is typically possible to achieve very high welding quality, but it is not possible to automate them in all circumstances, and, particularly in comparison with the method that will be explained in the following, they are associated with only relatively low productivity due to the lower melting performance and welding speed thereof.

In Gas Metal Arc Welding (GMAW), a wire electrode is fed continuously to the welding torch and melted in a welding arc, and is thus also a filler material. At least one process gas is also used. Depending on the type of the one or more process gas(es), the person skilled in the art makes a distinction between Metal Inert Gas (MIG) welding and Metal Active Gas (MAG) welding. The fundamental principles of the processes are similar. Typically, the welding current, the wire electrode, the process gas and any cooling water necessary are supplied to the GMAW torch through a set of hoses.

GMAW processes enable increased melting performance and welding speed, and thus also greater productivity than TIG processes. GMAW methods lend themselves extremely well to automation. However, one disadvantage associated with the use of the filler material that is heated, melted and vaporised directly in the welding arc is the significantly more abundant emission of particles compared with TIG processes. Moreover, the welding quality that is achievable with GMAW processes is often considered to be lower than that obtained with TIG methods.

Unlike the methods described in the preceding, in which the welding arc burns freely, in the plasma welding methods, which are also known, it is constricted by the use of copper nozzles, which are usually water-cooled. This has the effect of making the welding arc cross section narrower. A non-melting electrode is also used in plasma welding. The “plasma MIG welding method” is a hybrid method, that is to say a plasma welding method in which a melting electrode is used. The charge carriers that are needed in order to create a plasma are each supplied by a plasma gas (argon or mixtures of argon, helium and/or hydrogen).

When plasma welding with a non-melting electrode, a welding arc can be formed inside the welding torch and/or between the welding torch and the workpiece (a “transferred” or “non-transferred” arc). A distinction is made between plasma arc welding with non-transferred arc, plasma arc welding with transferred arc, and the combination process, plasma arc welding with non-transferred and transferred arc.

The process known as “plasma MIG welding” uses a consumable electrode and a plasma arc between a plasma gas nozzle and the workpiece that is being processed. The plasma arc is constricted by means of a “focussing gas nozzle” in conjunction with a corresponding focussing gas. The plasma gas nozzle, the focussing gas nozzle and the shielding gas nozzle, which is also present, are arranged coaxially. The melting wire electrode, which is used as in conventional GMAW methods, is fed centrally. Both the plasma gas nozzle and the wire electrode usually have positive potential and are typically supplied by separate current sources. Pulsed currents or alternating current can be used.

These plasma welding methods all suffer from the same drawbacks as the TIG and GMAW methods described in the preceding. Accordingly, there is a need to improve said welding processes.

### SUMMARY OF THE INVENTION

Against this background, the invention provides for a welding torch having guidance means for potential-free guidance of a wire-like welding filler material, a welding apparatus comprising such a welding torch, a corresponding welding method (also called “process” in the context of welding technology) and the use of at least one process gas.

In one embodiment of the invention, there is disclosed a welding torch comprising guidance means designed to advance a wire-like welding filler material mechanically along an axis at least in a section of the welding torch having at least one process gas nozzle that coaxially surrounds at least the guidance means and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector.

In another embodiment of the invention, there is disclosed a welding apparatus comprising a welding torch having guidance means designed to advance a wire-like welding filler material mechanically along an axis at least in a section of the welding torch having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, a feed device configured to supply the wire-like welding filler material to the guidance means, a process gas unit configures to supply at least one process gas to the process gas nozzle of the welding torch, and a welding current source that is configured to charge the welding current connector with a welding current.

In another embodiment of the invention, there is disclosed a welding method wherein a welding torch having guidance means designed to advance a wire-like welding filler material mechanically along an axis at least in a section of the welding torch, having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, comprising feeding a process gas to the process gas nozzle of the welding torch and the welding filler material is advanced in potential free manner without an electrical connection to the welding current connector by the guidance means.

In another embodiment of the invention, there is disclosed a welding method wherein a welding apparatus comprising a welding torch having guidance means designed to advance a wire-like welding filler material mechanically along an axis at least in a section of the welding torch, having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, a feed device configured to supply the wire-like welding filler material to the guidance means, a process gas unit configures to supply at least one process gas to the process gas nozzle of the welding torch, and a welding current source that is configured to charge the welding current connector with a welding current, comprising feeding a process gas to the process gas nozzle of the welding torch and the welding filler material is advanced in potential free manner without an electrical connection to the welding current connector by the guidance means

The starting point for the invention is a welding torch with guidance means that are designed to advance a wire-like welding filler material mechanically along an axis at least in a section of the welding torch. At least one process gas nozzle is provided and encloses at least the guidance means coaxially. Such a welding torch is typically equipped with a welding current connection, which is connected to an element of the welding torch configured to conduct current.

As was explained in the introduction, in conventional welding torches for GMAW processes, the element of the welding torch that is configured to conduct current is the welding filler material. Thus, in the GMAW process the welding filler material is charged with the welding current. A welding arc forms between the welding filler material and the workpiece. On the other hand, in the TIG method that is also explained, the tungsten electrode is the element that is configured for conducting the current. If a filler material is used in this case, it must be fed to the arc externally, that is to say eccentrically. This is assured either manually or mechanically. The disadvantages described in the foregoing are associated with both processes, but these are overcome with the present invention, as will be explained in the following.

According to the invention, the welding torch comprises a hollow electrode that coaxially surrounds the axis along which the wire-like welding filler material is advanced by the guidance means. Said hollow electrode is designed as the element configured to conduct the current, and as such is connected to the welding current connector. In this context, the hollow electrode is preferably the only element that is configured to conduct the current. Thus, the filler material is not connected to the current source and is potential free during a corresponding welding process. The welding torch according to the invention is thus notable for the fact that the guidance means described are designed for potential free guidance of the wire-like welding filler material without establishing an electrical connection between the welding filler material and the welding current connector. In particular, they are electrically insulated from the welding current connector, and/or themselves serve to insulate the welding filler material from the welding current connector.

All materials known from the prior art may be used as welding filler materials. Known filler materials are provided in the form of wires with diameters between 0.6 and 2.4 mm, but they may also have other dimensions. A “wire” or filler material does not generally have to have a circular cross section. The cross section may also be oval, rectangular, square or triangular, for example, or other shapes may also be used. Welding filler materials in the form of flat wires or strips are also known. The corresponding materials may further include arc stabilisers, slag formers and alloying elements, for example, which promote smooth welding, contribute to advantageous protection of the weld seam as it solidifies, and enhance the mechanical quality of the weld seam that is produced. Filler materials may be employed as solid wires (“wire” in the sense described above) or as “cored wires”, such as are known in principle from the prior art. Depending on the specific physical conditions that are produced within the scope of the present invention, such as a change in the interaction between the welding filler material and the arc (which is now no longer formed between the filler material and the workpiece or another torch element, but rather between the hollow electrode and the workpiece or other torch element), a person skilled in the art can also develop new welding filler materials for specific applications. The uncoupling of the current supply from the welding filter material opens up new possibilities for influencing the material. This in turn enables the creation of new recipes as required.

As a result of the measures suggested, the present invention combines the respective advantages of the GMAW and TIG methods. In particular, use of the inventive welding torch enables the high productivity and welding speed of GMAW processes to be achieved. At the same time, the high welding quality of TIG processes can also be achieved by using the inventive welding torch. Since the terms of the present invention provide that the filler material is not charged with the welding current, particle emissions are markedly lower than for known GMAW processes. This is because in the scope of the present invention the welding filler material is not heated, melted and vaporised directly in the welding arc, but is liquefied relatively gently.

In other words, the present invention provides a joining technology that offers the melting performance and automation capabilities associated with known GMAW processes, but also has the low emissions and high welding quality of a TIG or plasma process.

As a result of the measures suggested in the scope of the present invention, plasma processes in particular can be carried out with the advantages described particularly easily and inexpensively, as will be explained in the following.

The invention can be used with various welding current configurations. It is known that most metals in TIG methods are welded using direct current and a negative electrode. However, this is not possible with aluminium and magnesium alloys, for example, which have low melting points and at the same time form dense oxide skins that do not melt readily. These materials are usually welded using alternating current, in which case the negative current components are used for thermal relief of the electrode. In this context, brief voltage peaks after each zero crossing or a high-frequency high voltage can be used to reignite the arc.

The scope of the present invention also particularly extends to cover the use of process gas streams that are variable with respect to composition or volume flow. This variation may be effected for example as a pulsation of the entire process gas, or a component thereof, at a preset frequency, as described for plasma plug welding in EP 2 277 655 A1 for example. As described in that document, the variation of the composition or volume flow, or even of the pulsation frequency, for example, is adjustable depending on at least one boundary condition of the welding process. These notes apply to all process gas streams, for example plasma gas, focussing gas and/or shielding gas.

In particular, the present invention also offers advantages compared with known processes that use a hollow electrode, e.g., TIG welding processes with hollow electrodes, which are used as niche applications in air and space travel. In applications of this kind, the filler material is supplied externally. Consequently, the welding torch can only be rotated about its longitudinal axis with relative difficulty, which in turn considerably limits the flexibility of such a method and the automated application thereof.

In contrast, it is possible within the scope of the present invention to enable the welding arc to rotate over the circumference of the hollow electrode or relative to the workpiece, which renders the process according to the invention extremely process-stable. Thus, the arc circulates periodically. For this purpose, for example a coil arrangement is integrated in the welding torch and generates an incident electrical and/or magnetic field by applying a suitable current charge about said axis. For this purpose, multiple individual coils, winding pairs or even permanent magnets may be arranged at intervals about the circumference of the welding torch, so that a rotating field can be created, like a stator in an electrical machine. This makes it possible to influence the respective position of the arc sparking on the hollow electrode. The rotating and orbiting frequencies can each be adjusted as necessary. The rotating frequency can be adjusted by a person skilled in the art as a function of welding parameters such as the current/voltage, welding position, electrode diameter, process gas, seam geometry, surface composition, welding speed, material, etc.

The invention also offers advantages over the known plasma GMAW processes, or the equally familiar plasma-laser hybrid methods that can be used with a hollow electrode, since in this case the welding filler material is not charged with a welding current, so fewer emissions are generated. It is also known that conventional plasma GMAW processes are quite unstable in execution. In such processes, the arc has a tendency to “stall” on the hollow electrode under certain circumstances, that is to say the arc stops moving about the circumference of the hollow electrode, damages it and also causes one-sided weld seam faults. These instabilities are also aggravated by the mutual electromagnetic effects between the current-conducting filler material and the hollow electrode. Both of these disadvantages are eliminated in the scope of the present invention, firstly because the arc originates from the hollow electrode, not from the filler material, and secondly because it can be controlled actively via the electrical and/or magnetic field.

The welding torch according to the invention may be designed with a hollow electrode of which at least sections are cylindrical and/or conical. For example, such a hollow electrode may be tapered toward the tip, that is to say the distal end of the welding torch, thereby creating a focussing effect. The shape of a corresponding electrode may also be adapted to a further, outer, coaxial gas nozzle, thus enabling particularly favourable geometrical configurations.

As was explained previously, for the purposes of the present invention the hollow electrode is in the form of a non-melting electrode, and is made from an appropriate material therefore.

A welding torch according to the invention advantageously has an annular process gas duct, which is disposed radially outside of the hollow electrode and coaxially surrounds the described axis along which the wire-like filler material is fed by the described guidance means. Such an arrangement enables the entire arc, or a plasma that is formed, to be entirely covered by a process gas (for example a shielding gas or a focussing gas). The invention thus makes it possible to produce extremely high-quality welds. This may be effected by the described coaxial process gas nozzle, which coaxially surrounds at least guidance means for the filler material.

A corresponding welding torch may also be constructed advantageously with an annular process gas duct that coaxially surrounds the axis described, but is arranged racially inside the hollow electrode. Such a process gas duct may be used for example to prepare a plasma gas, as explained in the preceding, and is formed by the hollow electrode itself or by another process gas nozzle.

In this context, according to the invention two or more process gas ducts may be used in the corresponding arrangement. For example, one annular process gas duct may be arranged radially inside the hollow electrode, and another process gas duct may be arranged radially outside thereof. Such a process gas duct may be used for example to prepare a plasma gas, as explained previously, and is formed by the hollow electrode itself or by another process gas nozzle.

For the plasma processes discussed earlier, plasma gases containing argon or mixtures of argon, helium and/or hydrogen are used. This makes the charge carriers required to generate the plasma available. In particular, a correspondingly constricted plasma beam or plasma arc may be also be bundled coaxially by coaxial blowing with cold, less electrically conductive gas (the focussing gas referred to earlier), and/or by a protective shielding gas envelope consisting of a gas that conducts heat well but is poorly ionisable (e.g., helium or argon/hydrogen mixtures). Welding torches that are used for plasma processes usually require an additional shielding gas, which typically consists of argon/hydrogen mixtures or of argon or argon/helium mixtures. Plasma processes are divided into plasma arc welding and plasma beam/plasma arc welding processes, as explained previously. The invention may be used in conjunction with all such processes. For detailed descriptions of the processes mentioned, the reader is referred to the technical publications cited in the introduction.

A welding torch according to the invention that may be used for such a plasma welding process has in particular a hollow electrode that is usable as a focussing gas nozzle, and which is configured to constrict a plasma beam or plasma arc created with the aid of a plasma gas. Inside the nozzle, a plasma gas is transported coaxially to the filler material. An annular duct or corresponding nozzle ring may be provided In order to prepare the plasma gas. The plasma beam created thereby is constricted by the focussing gas, which is supplied coaxially outside of the plasma gas, for example via the aforementioned process gas nozzle. Typically, a process gas nozzle used for this purpose is water-cooled and tapered conically. A corresponding arrangement may be surrounded by another annular process gas duct, via which a shielding gas may be introduced. The hollow electrode may also be designed with cooling water ducts.

Constriction by means of the focussing gas and/or the aforementioned focussing gas nozzle results in an arc with a considerably smaller cross section than a freely burning arc. An almost cylindrical arc discharge with high power density is created. Accordingly, plasma processes differ from other arc welding processes essentially in the provision of means for constricting the welding arc. In plasma processes, the high degree of ionisation is achieved, which results in a particularly stable arc. Plasma processes are particularly preferable to conventional arc welding methods when small current strengths of less than one Ampère are involved.

A welding apparatus comprising a welding torch of the kind described previously is a further object of the present invention. Such a welding apparatus comprises means that are configured to supply the welding filler material to the aforementioned guidance means. In addition, at least one process gas device is provided, and is configured to provide at least one process gas to a welding nozzle of the welding torch. A corresponding welding apparatus is also provided with a suitable welding current source that is configured to charge the welding current connection with a welding current. All said means are preferably connected to a suitable controller, with which it is possible to adjust all parameters of the welding operation.

A welding method in which the aforementioned welding torch and/or corresponding welding apparatus is used is a further object of the present invention. In such a welding method, the hollow electrode is charged with a welding current and the filler material is fed in a potential free manner. Regarding the features and advantages of the welding method according to the present invention, the reader is referred to the preceding notes.

In particular, a corresponding welding method may be carried out as a TIC or plasma welding method. The respective process features of these methods have been explained in the preceding text. Particularly in the case of plasma welding, a transferred or non-transferred arc can be used, that is to say an arc that is ignited between the welding torch and the workpiece or only inside the torch. Combinations of such are also possible.

According to one particularly advantageous method, the arc is made to rotate by means of a magnetic and/or electrical field set up around axis that has been mentioned several times previously, so that the arc rotates (circulates) around the circumference of the hollow electrode, thereby stabilising the process.

In particular, the present invention also entails the use of multiple process gases in a welding torch, as was explained previously, and a corresponding welding apparatus and method, wherein the one or more process gas(es) and the metallurgy of the material to be joined, and that of the filler material, must all be taken into account as well as the compatibility thereof with the non-melting hollow electrode. Essentially, such gas(es) may be argon or argon-based gas mixtures with additional inert (helium), oxidising (oxygen and/or carbon dioxide), reducing (hydrogen) or reactive (nitrogen and nitrogen compounds) components.

### BRIEF DESCRIPTION OF THE DRAWINGS

The present invention will now be explained in greater detail with reference to the accompanying drawings, which show preferred embodiments of the invention.

FIG. 1 is a diagrammatic lengthwise cross sectional view of a welding torch according to an embodiment of the invention.

FIG. 2 is a diagrammatic lengthwise cross sectional view of a welding torch according to an embodiment of the invention.

FIG. 3 is a diagrammatic view of a welding apparatus according to an embodiment of the invention.

In all figures, equivalent elements are designated with the same reference signs, and for purposes of clarity are not shown again.

### DETAILED DESCRIPTION OF THE INVENTION

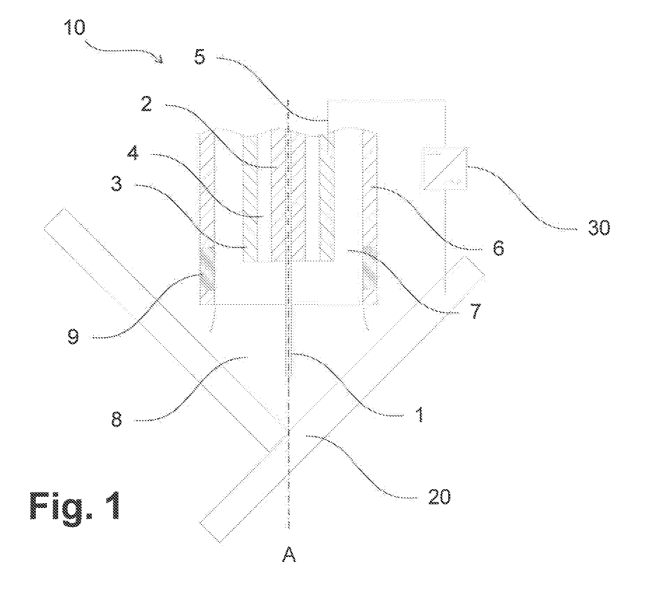

FIG. 1 shows a diagrammatic lengthwise cross sectional view of a welding torch according to an embodiment of the invention. Only a part of the welding torch is shown, and it is designated overall with the numeral 10. FIG. 1 shows the distal end of welding torch 10, aimed at a workpiece 20, which consists of two elements to which no reference numeral has been assigned.

Welding torch 10 is configured to advance a wire-like filler material 1. The wire-like filler material 1, which may consist of solid or cored wire filler material, both of which are known per se, (may also have an oval, flat or other cross section), is advanced in potential free manner along an axis A via guidance means 2 in the illustrated section of welding torch 10. In the illustrated section of welding torch 10, guidance means 2 may be constructed for example as a guide sleeve with a suitable diameter.

A hollow electrode 3 surrounds axis A, along which welding filler material 1 is advanced in the illustrated section of welding torch 10 by guidance means 2. In the example shown, hollow electrode 3 is cylindrical, but it may also be designed to taper toward the distal end of welding torch 10, that is to say toward workpiece 20. Hollow electrode 3 may be accommodated in an electrode holder—not further shown.

In the example shown, an annular process gas duct 4 is formed between hollow electrode 3 and guidance means 2, through which duct a suitable process may be fed. For example, a plasma gas as mentioned in the preceding may be fed via process gas duct 4 if the welding torch is to be used for a corresponding plasma welding process.

Hollow electrode 3 is connected to a terminal of a suitable welding current source 30 via a welding current connector 5, only indicated in outline in the figure. In this way, hollow electrode 3 may be charged with a suitable welding current, as explained previously. Welding current source 30 is preferably configured to deliver a direct and/or alternating current. In the example shown, workpiece 20 is connected to the other terminal of the welding current source 30, so that a welding arc may be formed between hollow electrode 3 and workpiece 20 (transferred arc). In the same way, however, another element of welding torch 10 may also be connected to the other terminal of the welding current source, so that welding arc is formed between hollow electrode 3 and said other element of the welding torch (non-transferred arc).

In the example shown, the arrangement of guidance means 2 with filler material 1 transported therein, hollow electrode 3 and process gas duct 4, is surrounded by a process gas duct 6, by which a further annular process gas duct 7 is defined externally to hollow electrode 3. The annular process gas duct 7 also coaxially surrounds axis A. For example, an area 8 may be covered entirely by a suitable shielding gas supply via process gas duct 7, so that neither workpiece 20 nor a weld seam is oxidised.

If, as explained, welding torch 10 is used for a plasma process, a focussing gas may also be introduced via nozzle 6. For this purpose, process gas nozzle 6 may also be designed as a conical focussing gas nozzle and/or it may be equipped with a suitable cooling device.

The arrangement illustrated may also be surrounded by additional process gas nozzles, which may be used for feed additional process gases. If a plasma gas is fed for example via annular process gas duct 4 and a focussing gas is fed for example via annular process gas duct 7, a shielding gas for example may be fed via a nozzle that is positioned farther out.

In the illustrated example, a highly schematic representation of a coil arrangement 9 to which a voltage source (not shown) may be applied is arranged inside process gas nozzle 6. In particular, coil arrangement 9 may also comprise a plurality of single coils distributed about a circumference of nozzle 6, arranged like the stator in an electrical machine, for example. An electrical and/or magnetic field applied about axis A may be generated by an actuating device known from the field of electrical engineering via coil arrangement 9, and set an arc produced between hollow electrode 3 and the workpiece (transferred) and/or an arc produced between hollow electrode 3 and another element of welding torch 10 (non-transferred) into rotating movement about axis A. The coil (or correspondingly distributed magnets) by which the field is induced and the arc is caused to rotate may also be attached to other positions of the torch, either integrated in the body of the torch or mounted on the inside or outside thereof.

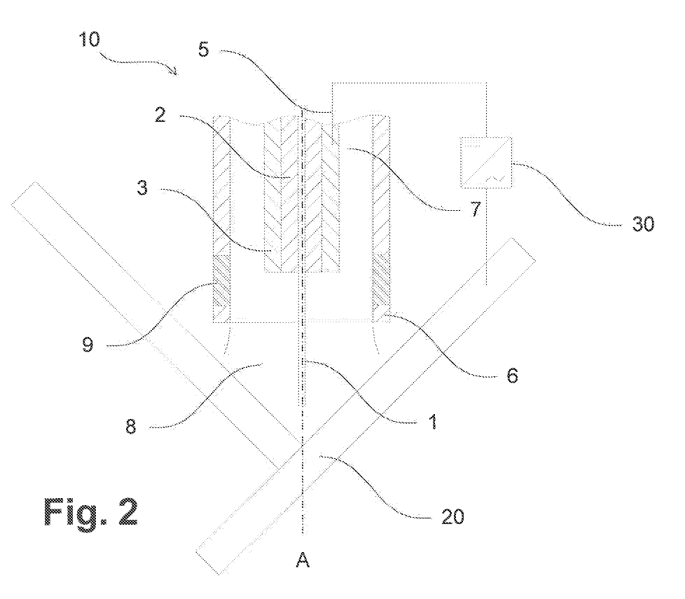

FIG. 2 shows a welding torch 10 according to another embodiment of the invention. The welding torch 10 in FIG. 2 is substantially the same as the torch in FIG. 1, but is of simpler design. Welding torch 10 in FIG. 2 is equipped with all the same elements as welding torch 10 in FIG. 1 except annular process gas channel 4. Consequently, it is easier to manufacture and the actuation technology required therefor can be less sophisticated. However, welding torch 10 is consequently also less versatile with regard to the welding for which it can be used. For example, it is not possible to supply focussing gas and plasma gas separately.

In the example shown in FIG. 2, guidance means 2 must be designed to insulate and/or be insulated from hollow electrode 3 to ensure that welding filler material 1 is potential free.

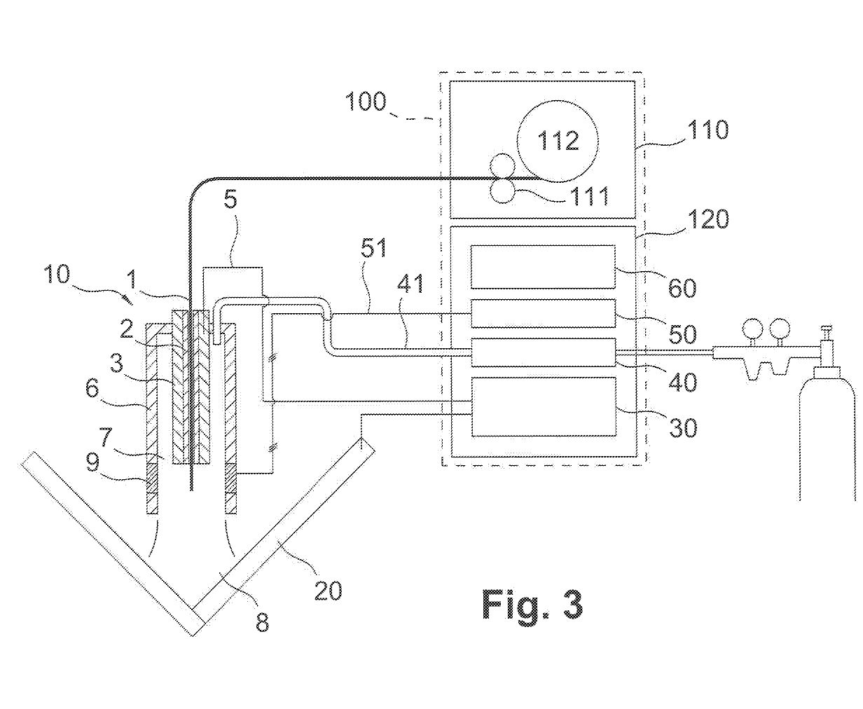

FIG. 3 is a diagrammatic representation of a welding apparatus comprising the welding torch 10 of FIG. 2. The welding apparatus as a whole is indicated by reference numeral 100 and may also comprise welding torches 10 of different designs, such as the welding torch 10 of FIG. 1.

Welding apparatus 100 comprises an advancing unit 110 for wire-like filler material 1, which may be unwound from a roll 112 and fed to guidance means 2 in said unit by motor-driven feed rollers 111.

Welding apparatus 100 further includes a control and regulation unit 120 in which, in the example illustrated, a welding current source 30 such as a suitably designed welding transformer may be arranged. As noted previously, one terminal of the welding current source 30 is connected to hollow electrode 3 via welding current connector 5, and the other terminal thereof may be connected either to the workpiece 20 or to another element of welding torch 10.

In order to supply at least one process gas, a process gas unit 40 may be provided. Such a unit is in turn connected to at least one gas storage device, represented diagrammatically, such as at least one compressed gas bottle. Process gas unit 40 is particularly configured for adjusting the pressure, composition and/or volume flow rate of at least one process gas. In particular, process gas unit 40 may also be configured to supply at least one pulsed process gas stream. In the example illustrated, process gas unit 40 is connected to annular process gas duct 7 via a line 41. The diagram is highly simplified, in particular, such a connection may also comprise multiple nozzles or nozzle arrangements. Of course, a plurality of process gas units may also be provided, and/or one process gas unit 40 may be connected with a plurality of annular process gas ducts 4, 7.

Coil unit 9 may be connected to a corresponding current source 50 via a corresponding line 51, for example a three-phase line 51. Current source 50 may comprise for example suitable (pulse) inverters and actuation units for providing suitable currents.

Welding current source 30, process gas unit 40 and current source 50 may be actuated by means of a control unit 60, which may also be connected to an external control computer, for example. Control unit 60 may be equipped with suitable regulating means and connected to sensor lines (not shown). Control unit 60 may also store and run suitable welding software.

Welding apparatus 100 may also comprise means (not shown) for supplying cooling water, user input units, digital and/or analogue displays and the like.

What we claim is:

1. A welding torch comprising guidance means designed to advance a wire-like welding filler material mechanically along an axis at least in a section of the welding torch having at least one process gas nozzle that coaxially surrounds at least the guidance means and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector.

2. The welding torch according to claim 1, further comprising a coil and/or magnet arrangement that is configured to supply an electrical and/or magnetic field applied around axis and designed to cause a welding arc originating from the hollow electrode to rotate about the axis.

3. The welding torch according to claim 1, in which at least one or more sections of the hollow electrode is cylindrical or conical in shape.

4. The welding torch according to claim 1, in which the hollow electrode is constructed as a non-melting electrode.

5. The welding torch according to claim 1, comprising an annular process gas duct that surrounds axis coaxially and is arranged radially inside the hollow electrode.

6. The welding torch according to claim 1, comprising an annular process gas duct that surrounds axis coaxially and is arranged radially outside the hollow electrode.

7. The welding torch according to claim 1, in which the process gas nozzle is designed to constrict a plasma beam that is generated using a plasma gas.

8. The welding torch according to claim 1, further comprising feeding a process gas to at least the process gas nozzle.

9. The welding torch according to claim 8, wherein the process gas is used as a plasma gas, a focussing gas or a shielding gas.

10. A welding apparatus comprising a welding torch having guidance means designed to advance a wire-like welding filler material mechanically along an axis at least in a section of the welding torch, having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, a feed device configured to supply the wire-like welding filler material to the guidance means, a process gas unit configures to supply at least one process gas to the process gas nozzle of the welding torch, and a welding current source that is configured to charge the welding current connector with a welding current.

11. The welding apparatus according to claim 10, in which the process gas unit is configured to provide at least one pulsed process gas stream.

12. The welding torch according to claim 10, further comprising feeding a process gas to at least the process gas nozzle.

13. The welding torch according to claim 12, wherein the process gas is used as a plasma gas, a focussing gas or a shielding gas.

14. A welding method wherein a welding torch having guidance means designed to advance a wire-like welding filler material mechanically along an axis at least in a section of the welding torch, having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, comprising feeding a process gas to the process gas nozzle of the welding torch and the welding filler material is advanced in potential free manner without an electrical connection to the welding current connector by the guidance means.

15. The welding method according to claim 14, which is performed as a Tungsten Inert Gas or Plasma welding process.

16. The welding method according to claim 14, in which a transferred or non-transferred welding arc is produced.

17. The welding method according to claim 15, in which the welding arc is caused to rotate by means of an electrical field applied around the axis or by means of a magnetic field applied around the axis.

18. The welding method according to claim 14, in which a pulsed welding current and/or a welding current with alternating polarity is used.

19. The welding method according to claim 14, in which a cored or solid wire with any cross section is used as the welding filler material.

20. The welding torch according to claim 14, further comprising feeding a process gas to at least the process gas nozzle.

21. The welding torch according to claim 20, wherein the process gas is used as a plasma gas, a focussing gas or a shielding gas.

22. A welding method wherein a welding apparatus comprising a welding torch having guidance means designed to advance a wire-like welding filler material mechanically along an axis at least in a section of the welding torch, having at least one process gas nozzle that coaxially surrounds at least the guidance means, and having a welding current connector that is connected in electrically conductive manner to an element of the welding torch that is configured to conduct electrical current, characterised by a hollow electrode that surrounds the axis coaxially and as the element configured for conducting current is connected in electrically conductive manner to the welding current connector, wherein the guidance means are designed to advance the welding filler material in potential free manner with no connection to the welding current connector, a feed device configured to supply the wire-like welding filler material to the guidance means, a process gas unit configures to supply at least one process gas to the process gas nozzle of the welding torch, and a welding current source that is configured to charge the welding current connector with a welding current, comprising feeding a process gas to the process gas nozzle of the welding torch and the welding filler material is advanced in potential free manner without an electrical connection to the welding current connector by the guidance means.

23. The welding method according to claim 22, which is performed as a Tungsten Inert Gas or Plasma welding process.

24. The welding method according to claim 22, in which a transferred or non-transferred welding arc is produced.

25. The welding method according to claim 23, in which the welding arc is caused to rotate by means of an electrical field applied around the axis or by means of a magnetic field applied around the axis.

26. The welding method according to claim 22, in which a pulsed welding current and/or a welding current with alternating polarity is used.

27. The welding method according to claim 22, in which a cored or solid wire with any cross section is used as the welding filler material.

28. The welding torch according to claim 22, further comprising feeding a process gas to at least the process gas nozzle.

29. The welding torch according to claim 28, wherein the process gas is used as a plasma gas, a focussing gas or a shielding gas.
